(19) United States
(12) Patent Application Publication
(10) Pub. No.: US 2010/0175941 A1
(43) Pub. Date: Jul. 15, 2010

(54) METHOD AND SYSTEM FOR PRODUCTION OF HYDROGEN

(76) Inventor: MOHAMMED KHODABAKHSH, Upland, CA (US)

Correspondence Address: Cislo & Thomas LLP, 1333 2nd Street, Suite #500, Santa Monica, CA, 90401-4110, US

(21) Appl. No.: 12/353,899

(22) Filed: Jan. 14, 2009

(51) Int. Cl. B60K 15/10; C25B 1/04; C25B 9/00; C25B 15/02

(52) U.S. Cl. 180/69.5; 205/628; 204/229.4; 204/229.2; 204/229.5; 205/335

(57) ABSTRACT

The present invention provides a signal generator device for generating an electrical signal for use in an electrolysis device. The signal comprises a waveform with a voltage, a duty cycle, and a frequency. These waveform parameters may be varied based on data received from a plurality of sensors. The signal generator may generate a second electrical signal superimposed with the first electrical signal.

### TECHNICAL FIELD

The present invention relates to electronic control systems in general, and more particularly, some embodiments relate to electronic control systems for operation of electrolysis devices.

### DESCRIPTION OF THE RELATED ART

Electrolysis of water to form hydrogen and oxygen gas is generally known in the art. The gasses produced by this process may be used for a variety of different purposes. For example, hydrogen may be injected into a car engine's intake manifold to increase fuel efficiency and reduce harmful or unwanted emissions.

Hydrogen fuel enhancement by the injection of hydrogen gas into a car engine's intake manifold is well known to increase fuel efficiency and reduce emissions. Hydrogen may be added to a vehicle's air/fuel mixture, thereby allowing the vehicle to run at a leaner air/fuel mixture than would be possible without the addition of hydrogen. This leaner fuel mixture allows the vehicle to perform with better fuel efficiency than would otherwise be obtained without the addition of hydrogen gas.

Conventional hydrogen fuel-enhancement systems use electrical energy generated by the vehicle's alternator to power an electrolysis device. The increased load on the alternator causes the alternator to place a heavier load on the gasoline engine, which negatively affects its fuel efficiency. In most systems, this reduction in efficiency due to increased generator load outweighs the benefits gained by the addition of hydrogen. Furthermore, it is well known that as electrolysis takes place the resistive properties of the liquid (i.e. water) change. Dissolved ions increase the resistivity of the electrolysis liquid, thus requiring increased energy to perform the electrolysis, which places an increased load on the alternator. In current on-board electrolysis devices, this increased requirement further reduces the fuel efficiency gained by the hydrogen injection system.

### BRIEF SUMMARY OF EMBODIMENTS OF THE INVENTION

According to various embodiments of the invention systems and methods are provided that generate a signal used to power an electrolysis device disposed in a vehicle. The signal can, in some embodiments, be configured as a pulse wave or a pulse-width-modulated signal to electrolyze the electrolysis liquid. In addition, the signal characteristics such as amplitude, duty cycle and frequency, can be adjusted based on a number of factors such as, for example, load on the engine, resistivity of the water, and so on. Accordingly, the signal can be generated based on data received from sensors disposed in a vehicle. The signal can be further configured to include a high-voltage pulse at the same frequency to charge the electrolysis device electrodes for capture of the produced gasses.

According to another embodiment of the invention, a generator is electrically coupled to an electrolysis device disposed in a vehicle, and is configured to receive data from one or more sensors and to generate the electrical signal to operate the electrolysis device. The generator and electrolysis device can be disposed in a vehicle to provide hydrogen injection into the vehicle's engine intake. The signal generated for use with the electrolysis device, can be a waveform comprising a minimum voltage, a maximum voltage, a frequency, and a duty cycle.

According to a further embodiment of the invention, the signal is a pulse waveform comprising a rectified pulse wave with a high voltage pulse superimposed at the low voltage portions of the pulse wave.

According to another embodiment of the invention, a method for providing an electrical signal for an electrolysis device comprises receiving data from a plurality of sensors; and generating an electrical signal based on the data to use in an electrolysis device disposed in a motor vehicle, the signal having a waveform comprising a minimum voltage, a maximum voltage, a frequency, and a duty cycle.

According to a further embodiment of the invention, the duty cycle of the waveform is varied based at least in part on data received from the sensors.

According to another embodiment of the invention, a vehicle with a hydrogen gas injection system, comprises: a generator electrically coupled to an electrolysis device disposed in a vehicle, wherein the generator is configured to receive data from a plurality of sensors and to generate the electrical signal from the data, and to generate an electrical signal for use in the electrolysis device. The signal has a waveform comprising a minimum voltage, a maximum voltage, a frequency, and a duty cycle, and provides the electrical signal to the electrolysis device; and wherein the electrolysis device is coupled to an air intake manifold and used to generate hydrogen gas.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The present invention, in accordance with one or more various embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

Some of the figures included herein illustrate various embodiments of the invention from different viewing angles. Although the accompanying descriptive text may refer to such views as “top,” “bottom” or “side” views, such references are merely descriptive and do not imply or require that the invention be implemented or used in a particular spatial orientation unless explicitly stated otherwise.

FIG. 1 depicts an overview of an electrolysis system and waveform generator in accordance with one embodiment of the invention.

FIG. 2 depicts an example set of sensors for use in accordance with one embodiment of the invention.

FIG. 3 is a functional block diagram of an example waveform generator in accordance with one embodiment of the invention.

FIG. 4 is a functional block diagram of an example waveform generator in accordance with one embodiment of the invention.

FIGS. 5A and 5B depict examples of waveforms that can be used to operate an electrolysis device in accordance with one embodiment of the invention.

FIG. 6 is an operational flow chart illustrating an example process for waveform generation in accordance with one embodiment of the invention.

FIG. 7 is a functional block diagram of a waveform generator with example input and outputs in accordance with one embodiment of the invention.

The figures are not intended to be exhaustive or to limit the invention to the precise form disclosed. It should be understood that the invention can be practiced with modification and alteration, and that the invention be limited only by the claims and the equivalents thereof.

### DETAILED DESCRIPTION OF THE EMBODIMENTS OF THE INVENTION

Embodiments of the present invention are directed toward systems and methods for providing generation of hydrogen through electrolysis. In one embodiment the system includes a waveform generator that produces a waveform having predetermined frequency, amplitude or duty-cycle characteristics to power an electrolysis appartus. The waveform can be, for example, a pulse-width modulated waveform and can further include a high-frequency component superimposed thereon. The hydgrogen generation system, including the waveform generator and electrolysis apparatus can be configured to operate so as to provide hydrogen atoms for a variety of applications, including for injection into an air intake system of a motor vehicle.

Before describing the invention in detail, it is useful to describe a few example environments with which the invention can be implemented. One such example is that of a gasoline- or diesel-powered vehicle that incorporates the waveform generator and the accompanying electrolysis device to produce hydrogen atoms for injection into he vehicle's air intake. From time-to-time, the present invention is described herein in terms of these example environments. Description in terms of these environments is provided to allow the various features and embodiments of the invention to be portrayed in the context of an exemplary application. After reading this description, it will become apparent to one of ordinary skill in the art how the invention can be implemented in different and alternative environments.

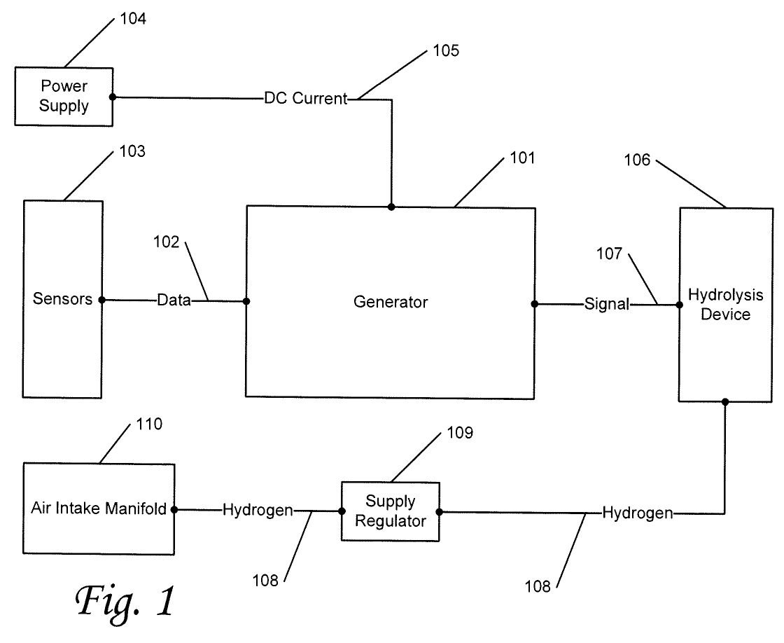

Referring now to FIG. 1, the illustrated example embodiment includes a power supply 104, a waveform generator 101, an electrolysis device 106, a supply regulator 109, an air intake manifold 110, and a plurality of sensors 103. According to this example of the invention, generator 101 is provided to generate a waveform 107 that is used to operate the electrolysis device 106. In this example, waveform 107 is generated based on data from the plurality of sensors 103. The generator is powered by power supply 104. Waveform 107 provides a voltage potential across an anode and cathode of the hydrolysis device 106, thereby resulting in the generation of hydrogen and oxygen atoms. In the illustrated example, hydrogen 108 generated in the electrolysis device 106 is regulated by the supply regulator 109 and provided to the vehicle's air intake manifold 110. In one embodiment, waveform generator 101 is a special-purpose module utilized to generate waveform 107. In other embodiments, waveform generator 101 comprises a module that is part of or shared with another system. For example, in the case of a motor vehicle, that vehicle's electronic control unit (ECU) or other computing or control system can be configured to perform the functions of waveform generator 101.

Although a dedicated power supply 104 may be provided, alternative power sources can be utilized. For example, the power supply 104 may comprise the vehicle's power supply. To this effect, in an automobile, motor home, semi or other like vehicle, the power supply 104 may comprise the vehicle's battery or alternator directly, or in other embodiments, the power may be drawn from the vehicle's electronic control unit. As another example of a shared power supply, in a hybrid vehicle, the power supply 104 may comprise the vehicle's battery or electronic control unit. As still a further example, a special-purpose battery, fuel cell, generator, solar cell, or other power source can be used as the power supply 104 for the system.

In various examples, the electrolysis device may be of the type disclosed in U.S. patent application Ser. No. 12/271,730, or any other type of electrolysis device. In various examples, the waveform 107 is a pulse wave signal that can comprise, for example, a pulse-width modulated signal. In some of these examples, waveform 107 may comprise a waveform of relatively high voltage superimposed on the pulse wave signal. For example, in one embodiment the pulse wave signal has pulses of relatively low voltage swings (for example, 0-5 volts, ±5 volts, etc.) between low and high states, and the high-voltage waveform has much higher voltage levels superimposed thereon. In one embodiment, the high voltage signal is superimposed such that it occurs at the low states of the pulse wave signal. In various other examples, the waveform 107 may comprise a DC current with a voltage of at least sufficient potential to enable the electrolysis of water into hydrogen gas and oxygen gas.

Although only one electrolysis device 106 is illustrated, it may be configured to include a plurality of electrolysis cells. Likewise, in further examples, the system may supply waveform 107 to a plurality of electrolysis devices 106. In these examples, the system may supply the same waveform 107 to each of the plurality of cells or devices 106 according to the needs of the engine. Alternatively, in other examples, the system may apply different waveforms 107 to various members of the plurality. For example, the system may apply a predetermined waveform to a first set of one or more electrolysis devices and may supply the same or a different waveform to a second set of one or more electrolysis devices, and so on, as more hydrogen is needed.

In alternative examples, the supply regulator 109 supplies hydrogen 108 generated by the electrolysis device 106 to the vehicle's air intake manifold 110. For example, the supply regulator 109 can act as a buffer to store excess hydrogen for injection into the air intake manifold 110 as needed. In some examples, the supply regulator is electrically coupled to and controlled by the generator 101. In other examples, the supply regulator is self controlled and electrically coupled to the sensor system. In these examples, the regulator is configured to calculate the needed amount of hydrogen from data provided by the sensors. In other examples, the supply regulator comprises a portion of the car's electronic control system, and the electronic control system generally calculates the amount of hydrogen injected into the air intake manifold. In other examples, the supply regulated is omitted entirely and all hydrogen produced by the electrolysis device is supplied immediately to the air intake manifold.

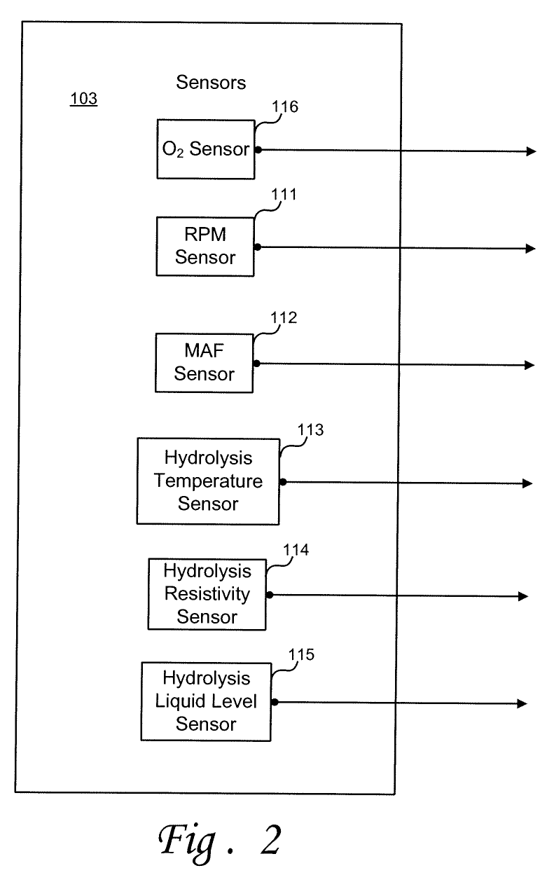

Referring now to FIG. 2, an example of a plurality of sensors used to provide data to the generator is shown. For example, sensors 103 may comprise sensors that provide data on the operating state of the engine, such as: (a) an automobile's oxygen sensor (O₂ sensor) 116, (b) an rpm sensor 111, and (c) a mass airflow (MAF) sensor 112. In various examples, the generator 101 receives the data from the sensors 103 themselves directly. In alternative examples, this sensor data may be supplied by the vehicle's electronic control unit (not shown) to the waveform generator 101. Sensors 103 may also include sensors that provide data on the operating state of the electrolysis device. Such sensor may include, for example: (a) a temperature sensor 113, (b) a resistivity sensor 114, and (c) a liquid level sensor 115. As these examples serve to illustrate, additional or other sensors may be used in conjunction with the system to provide data that can be used by waveform generator 101 to generate appropriate waveforms 107 or to regulate supply of hydrogen 108 to air intake manifold 110.

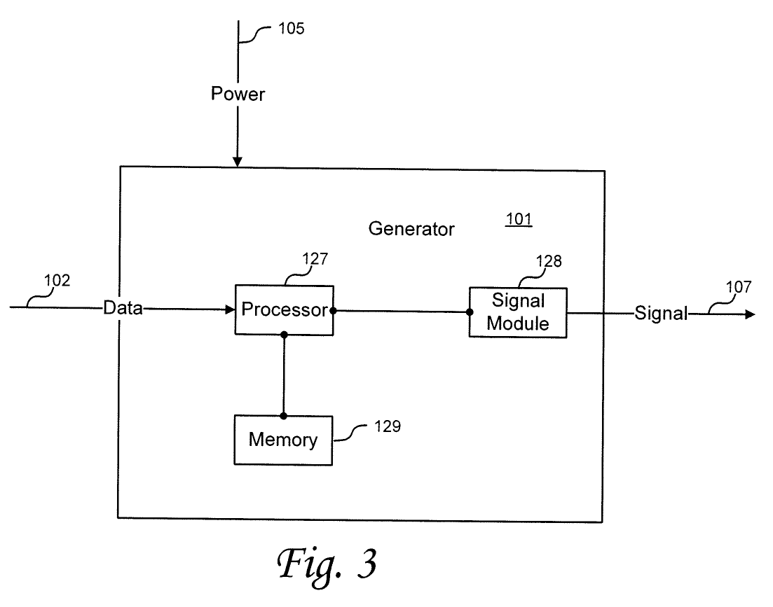

Referring now to FIG. 3, an example implementation of a waveform generator 101 is described. In this example, generator 101 might include, for example, one or more processors, controllers, control modules, or other processing devices, such as a processor 127. Processor 127 might be implemented using a general-purpose or special-purpose processing engine such as, for example, a microprocessor, controller, or other control logic. Generator 101 may further comprise a signal producing module 128 and a memory module 129. The processor computes a desired waveform for the signal 107 based on data 102 provided by the sensor system (not shown). The desired signal 107 is generated by the signal producing module 128. In various examples, the processor computes the desired waveform in real time based on incoming data from the sensors.

In alternative examples, the generator module 101 further comprises a memory 129. For example, preferably random access memory (RAM) or other dynamic memory, might be used for storing information and instructions to be executed by processor 127. Memory 129 might also be used for storing temporary variables or other intermediate information during execution of instructions to be executed by processor 127. Generator 101 might likewise include a read only memory (“ROM”) or other static storage device for storing static information and instructions for processor 127. In these examples, the processor module may be configured to generate a waveform based on current data coming from the sensor system and on past data previously provided by the system. In other examples, the generator is configured to provide a particular waveform without regard to data, such a waveform being calculated to provide hydrogen operation in all engine operative modes.

In particular examples, the processor module 127 provides the desired waveform to the signal producing module 128. The signal producing module 128 then forms the waveform for the signal. Those of ordinary skill in the art will appreciate various equivalent architectures or configurations that form a desired signal based on incoming data without departing from the scope of the invention.

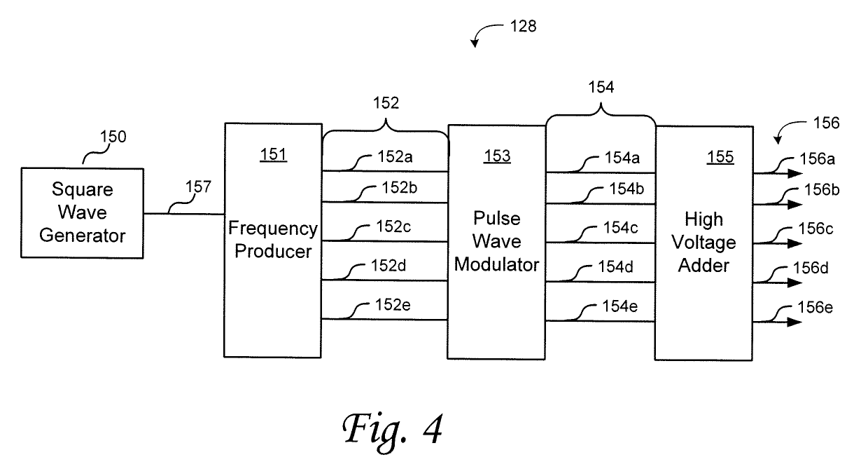

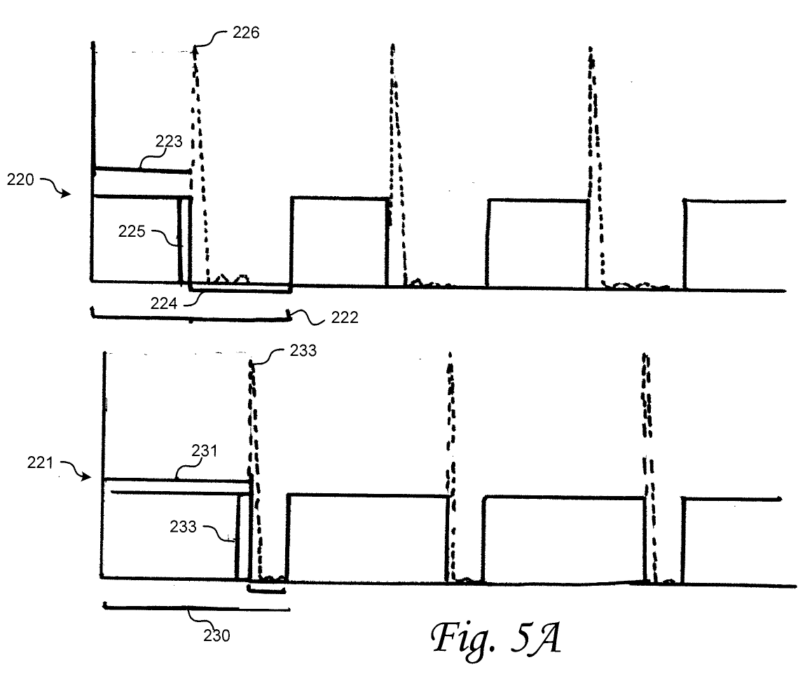

Referring now to FIG. 4, an example embodiment of a signal producing module 128, as described above, may be used to create a plurality of waveforms 156 for use in an electrolysis device. In this example, a first signal generator such as square wave generator 150 provides a square wave signal 157 to a second signal generator such as frequency producer 151. Square wave generator 150 may be any square waveform generator as known in the art. For example, square wave generator 150 may comprise a comparator electrically coupled to a capacitor and various resistors as known in the art for generating a square wave. In some examples, square wave generator is configured to output a square wave 157 that varies between a maximum voltage and a minimum voltage. To avoid the generation of oxygen at the hydrogen electrode of the electrolysis device, in these examples the minimum voltage has the same sign as the maximum voltage. For example, in some examples, the square wave varies between a +12 V maximum voltage and 0V minimum voltage. In other examples, a square wave that varies symmetrically between a maximum and minimum voltage that has the same absolute value, for example between +12V and −12 V. In these examples, the waveform may be modified later for proper conformation with the requirements for an electrolysis device. For example, the square wave may be passed through a rectifier as known in the art to provide a waveform that varies between 0 V and +12 V.

Referring still to FIG. 4, a second signal generator such as frequency producer 151 provides a frequency-adjusted square wave 152 to pulse wave modulator 153. Frequency producer 151 may be electrically coupled to the processor or processing module and configured to provide a waveform with a frequency configured to enable efficient generation of hydrogen in an electrolysis device. Frequency producer 151 may comprise a frequency divider to provide a frequency adjusted square wave 152 with a frequency which is a rational number multiple of the initial square wave 157. Frequency producer 151 may be any module which adjusts the frequency of an input signal in order to supply an output signal with an adjusted frequency. For example, the frequency producer could be implemented using an analog frequency divider such as a regenerative frequency divider or an injection-locked frequency divider, a digital signal divider, or a fractional-n divider.

In the illustrated example, frequency producer 151 includes a plurality of signal generators such as dividers to provide a plurality of output signals 152a-e at a plurality of different frequencies. In these examples, the generator 128 may select from the plurality of discrete frequencies depending on the hydrogen needs of the engine. In further examples, frequency generator 151 may be configured to output a waveform 152 which may vary continuously in frequency. In this example, the generator may select the preferred frequency to be generated based on the hydrogen needs of the engine. Those of ordinary skill in the art will appreciate other methods for generating frequencies for use in an electrolysis device without departing from the scope of the present invention.

Referring still to FIG. 4, in some examples, a pulse wave modulator 153 that is electrically coupled to the processor is configured to modulate the duty cycle of the waveform 152 in accordance with the needs of the engine. For example, if increased hydrogen output is required, pulse wave modulator may increase the duty cycle so that power is being provided to the electrolysis device over a longer period in each wavelength. Pulse wave modulator may comprise any analog or digital system or architecture known in the art for varying the duty cycle of an electrical signal or waveform. In some examples, the frequency producer 151 outputs a single square wave waveform that varies in frequency. In these examples, the pulse wave modulator outputs a single pulse wave waveform 154 in accordance with the power needs of the electrolysis device. In examples comprising a plurality of frequency adjusted waveforms 152a-e, pulse wave modulator 154 may be configured to output a plurality of pulse wave waveforms 154a-e corresponding to the number of frequency adjusted waveforms 152a-e. In these examples, pulse wave modulator 153 may comprise a plurality of separate pulse adjusting modules, or may comprise a single system that is able to act on each frequency adjusted waveform.

Referring still to FIG. 4, in some examples, a high voltage adder 155 is configured to output a final waveform 156 with a high voltage waveform superimposed onto the pulse wave 154. In these examples, high voltage adder 155 is configured to superimpose a high voltage waveform onto the minimum voltage portion of the pulse wave 154. High voltage adder 155 may comprise any analog or digital circuit configured to output a high voltage waveform. In a further example, high voltage adder 155 may be configured to superimpose the derivative of the pulse waveform on the pulse waveform. In this example, the high voltage adder may comprise operational amplifiers, capacitors, and resistors electrically coupled into a derivator circuit configuration as known in the art.

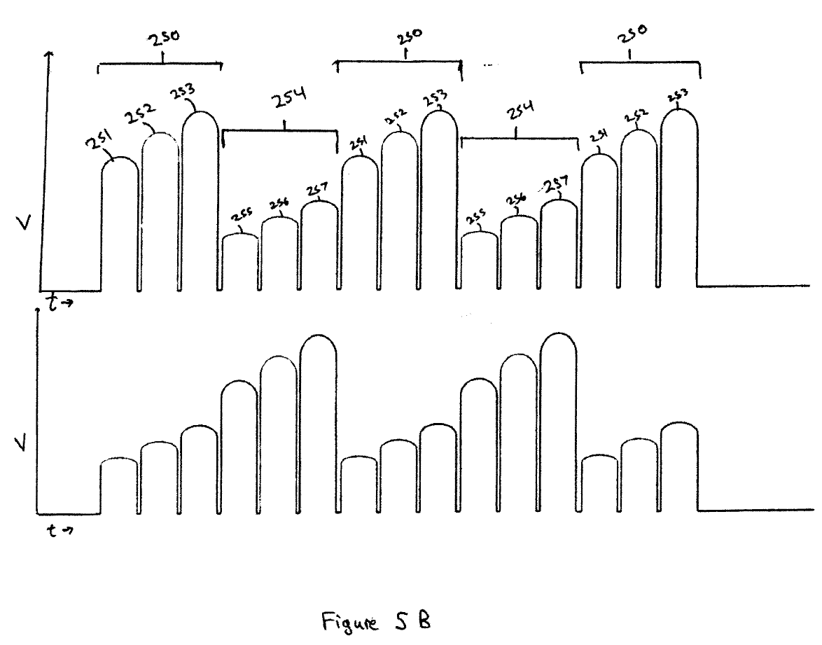

Referring now to FIG. 5A, a few exemplary output waveforms 220 and 221 are now described. As discussed above, the output waveform is applied across two electrodes of an electrolysis device to break the hydrolysis fluid into its constituent components. In the case of breaking water into hydrogen and oxygen, hydrogen gas forms at the positively charged cathode and oxygen gas forms at the negatively charged anode. In order to ensure that the desired gas is produced at the proper electrode, the polarity of the signal should not be reversed. For example, the terminal designated as the cathode should not be negatively charged during operation. Therefore, it is preferable that the minimum and maximum voltage of the output signal maintain the same sign. In examples, where a mixture of hydrogen gas and oxygen gas, or Brown's gas, is acceptable or desired, the maximum and minimum voltages may be of different signs.

FIG. 5A presents two plots of final output signals 220 and 221 on a graph with voltage and time axes. The voltage scale depicted in this example is not a linear scale, and is illustrative of the described principles only. Although the waveforms 220 and 221 are shown to be substantially ideal (for example, sharp transitions, no ringing), non-ideal waveforms may be used. Although waveforms that correspond to at least the first twelve harmonics of the Fourier transform of an ideal square or pulse wave may preferably be used, more or less than twelve harmonics may be used in approximating an ideal square or pulse wave. Alternatively, other waveforms, such as a triangular or sinusoidal waveform or other waveform may be used.

Referring still to FIG. 5A, in various examples, output waveform 220 comprises a square wave with a periodicity 222. Output waveform 220 can be further characterized by a duty cycle, which is the ratio of the active pulse length 223 and the inactive pulse length 224. In the illustrated example, output waveform 220 has an approximately 50% duty cycle because the active pulse length 223 is approximately 50% of the total wavelength 222. Output waveform 220 further comprises a voltage swing 225 between low and high states, which in this example is approximately 12 volts. As illustrated by dashed waveform 226, output waveform 220 may further comprise a high voltage waveform with a peak voltage of Vₕ superimposed on the lower voltage pulse waveform. Output waveform 220 is configured and generated by the generator to produce hydrogen gas in an electrolysis device.

In the illustrated example, an output signal 220 comprises a 12-volt peak-to-peak square wave with +12V maximum voltage and 0V minimum voltage with a 50% duty cycle. The periodicity 222 may correspond to a desired frequency, which in one embodiment is approximately 43,430 HZ. This frequency can be chosen and adjusted to improve the efficiency of the production of hydrogen. In some examples, a plurality of secondary wavelengths corresponding to subharmonics of the first wavelength may also be provided. For example, a primary wavelength at 43,430 Hz, a first harmonic of 21,715 Hz, a second harmonic of 14,476.67 Hz, a third harmonic of 15,517.5 Hz and a fourth harmonic of 8,686 Hz may be provided. In these examples, the inclusion of the sub harmonics may be optional, for example, the fourth harmonic may sometimes be omitted. In other examples, a frequency in the range of 42 kHz-45.8 kHz is chosen. In further examples, a wavelength with a frequency of 143,762 Hz may be chosen. In these examples, sub harmonics may also be included, for example: a first harmonic of 71,881 Hz, a second harmonic of 47,920.67 Hz, a third harmonic of 35,840.1 Hz, and a fourth harmonic of 28,752.4 Hz. Or, in other examples, a frequency in the range of 110 kHz to 180 kHz may be chosen.

In the illustrated example, high voltage waveform 226 comprises a waveform with a brief peak at a high voltage Vₕ. The high voltage waveform may serve multiple uses in the electrolysis device. For example, high voltage waveform 226 may provide a brief burst of voltage that serves to cleanse the electrolysis device's electrodes of built up ions, which increase the resistance of the electrolysis liquid. Or for example, high voltage waveform 226 may serve to degas the electrolysis fluid by cleansing the electrodes of aqueous dissolved hydrogen and oxygen molecules. In particular examples, waveform 226 may comprise a 1,500 V brief DC pulse that corresponds to a derivative of the voltage drop of the square wave portion of output signal 220. In other examples, high voltage waveform 226 may comprise an AC pulse with a peak-to-peak voltage of 1,500 V. In various examples, the AC pulse may alternate current at a ultrahigh frequency of: 2.9 GHz, 3.8 GHz, or 4.7 GHz. In further examples, a second alternating current at a very high frequency of: 380 MHz, 470 MHz, or 650 MHz may be superimposed with the ultrahigh frequency through any method known in the art. Those of ordinary skill in the art will appreciate other potential waveform characteristics and other methods for forming a high voltage waveform without departing from the scope of present invention.

Referring still to FIG. 5A, output signal 221 illustrates another example output signal for use in an electrolysis device. This example illustrates the use of a varied duty cycle. In the illustrated examples, wavelength 230 is substantially the same as wavelength 222, and thus output waveform 221 has substantially the same frequency as output waveform 220. However, active pulse length 231 is longer than active pulse length 223 and inactive pulse length 232 is less than inactive pulse length 224, corresponding to a greater duty cycle. In the illustrated example, the duty cycle of output waveform 221 is approximately 75%. Therefore, output waveform 221 contains 50% more power than output waveform 223. All other factors being equal, hydrogen gas production in an electrolysis device will typically increase with increased duty cycle under normal operating conditions. Thus, by varying the duty cycle, the hydrogen production may be adjusted without varying the voltage or frequency. This may be beneficial when the voltage and frequency are chosen for most efficient production of hydrogen.

Referring now to FIG. 5B, this example illustrates an alternative electrical output 249. The example output 249 may comprise a series of pulses, with a pulse width 258 and an inactive width 259. In some examples, the pulse group 250 comprises high voltage pulses directed to collection electrodes disposed within an electrolysis device. In these examples, the pulse group 254 is directed to formation electrodes disposed within an electrolysis device. In further examples, the electrolysis device does not have separate collection and formation electrodes. In which case, the pulse groups 250 and 254 are directed to the same electrodes. In the example illustrated in FIG. 5, pulse group 254 comprises three separate pulses 255, 256, and 257 of approximately equal pulse width. These pulses 254 and 250 may each be modeled as three separate pulse train waveforms with small duty cycles superimposed upon each other at a phase difference of approximately one pulse width. In some examples, the duty cycle of each pulse in the pulse group may be independently modified. In other examples, the duty cycle of the entire pulse group may be modified. In particular examples, the duty cycle may vary between 10% and 90%. In various examples, the pulse groups 250 may serve as high voltage pulses that charge electrodes in an electrolysis device for collecting hydrogen and oxygen ions formed during electrolysis. In these examples, the pulse groups 254 may serve to supply the energy needed for the electrolysis reaction.

In particular examples, the pulses 251, 252, and 253 may each have the same voltage, for example a voltage of between 450 V and 10,000 V. In other examples, some or all of the pulses may each have a different voltage, for example pulse 251 at 450 V, pulse 252 at 550 V, and pulse 253 at 650 V. In further examples, the pulses 255, 256, and 257 may each have the same voltage, for example a voltage between 6 V and 12 V. In other examples, the pulses 255, 256, and 257 may each have a different voltage, for example pulse 255 at 6 V, pulse 256 at 10 V, and pulse 257 at 12 V. In some further examples, a second output substantially similar to output 249 but at a lower frequency, for example: 3,000 Hz may be introduced to the electrolysis device. This second output may be introduced at a second set of electrodes in the electrolysis device, or may be superimposed with the first output and introduced at a single set of electrodes. In alternate examples, multiple further outputs may be introduced in a similar manner.

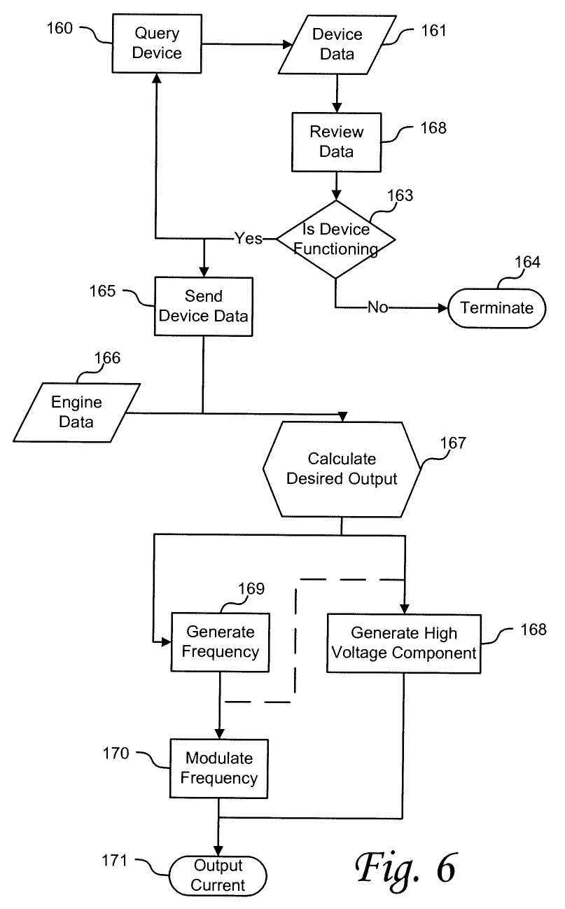

Referring now to FIG. 6, an exemplary flow chart of a system and method for efficient generation of hydrogen is presented. At step 160, the electrolysis device is queried for data and the data provided at step 161. Device data may comprise, for example, data concerning: (1) fluid levels, (2) resistivity of the electrolysis liquid, and (3) temperature of the electrolysis liquid. At step 162 the device data is reviewed and analyzed. The review and analysis may comprise analyzing the liquid levels to make determine whether or not there is sufficient reserve liquid to continue operation of the electrolysis device. Or, in other examples, the review and analysis may comprise analyzing the resistivity or temperature sensor data. For example, if the resistivity is determined to rapidly change, this may indicate a fault in the device or circuit requiring termination. Or if the resistivity or temperature exceed a predetermined operating bound, the device may require termination.

At decision step 163, it is determined whether the device is functioning. If the review and analysis step 162 indicates that the device is not functioning properly, then the device terminates as indicated in block 164. If the device is determined to be functioning properly, then at step 165 the device data is sent to a processor for waveform calculation. Additionally, if the device is functioning, then query step 160 may be repeated for iterative examination of device functionality.

At step 166, a desired output is calculated. In this example, the output waveform can be determined at least in part from engine data 166 and device data provided in step 165. Engine data 166 may comprise, for example, data from: (1) the engine's O₂ sensor, (2) the RPM sensor; and (3) the MAF or MAB sensor. Device data 161 and engine data 166 can be sampled and updated periodically to allow dynamic ongoing adjustment of the output waveform.

In various examples, calculation step 167 may comprise reviewing the device data 161 and engine data 166 to determine desired output waveforms. For example, if the engine is placed under an increased load, such as during acceleration, then the calculation may call for an increased amount of hydrogen. In this case, the amount of power provided to the electrolysis device may be increased. As noted above, this can be increased by, for example, increasing the output waveform duty cycle or by increasing voltage. In other examples, the engine data may indicate that the engine is under a light load, such as during cruising under constant velocity or coasting to a stop. Therefore, the calculation may indicate that less hydrogen is needed in the mixture. In this case, the amount of power provided to the electrolysis device may be decreased by lessening the output waveform's duty cycle or voltage.

In further examples, a high voltage waveform is determined and included to facilitate the production of hydrogen in the electrolysis device. For example, the data from the device may indicate that the resistivity of the device is increasing, thus lowering the efficiency of the device. In this example, a high voltage waveform may be provided to charge the electrolysis device's electrodes briefly in such a way to eliminate excess dissolved ions in the electrolysis liquid, thus increasing the device efficiency. In alternative examples, multiple desired waveforms may be calculated and applied. For example, an ultrahigh frequency (UHF) waveform and a very high frequency (VHF) waveform may be determined and applied in a combined manner. In some examples, these multiple waveforms may then be provided at separate outputs and superimposed for use in the electrolysis device. In other examples, these multiple waveforms may be provided at separate outputs and utilized to operate different cells at a multi-cell electrolysis device at different operating waveforms.

At step 169 a frequency portion of the calculated waveform is formed. In alternative examples where multiple desired waveform are calculated, step 169 may comprise forming one or more frequency portions of the multiple desired waveforms. Step 168 may comprise forming the high voltage component calculated in step 167. In some examples, the high voltage component may be formed separately from the frequency component. In other examples, the frequency component may be utilized in the formation of the high voltage component, such as through the use of a differentiator op amp circuit, for example. At step 170 the duty cycle of the output waveform is modulated according to the need calculated in step 167. At step 171 the formed output waveform is provided to the electrolysis device. In those examples comprising multiple desired output waveform, these output waveform are provided at step 171.

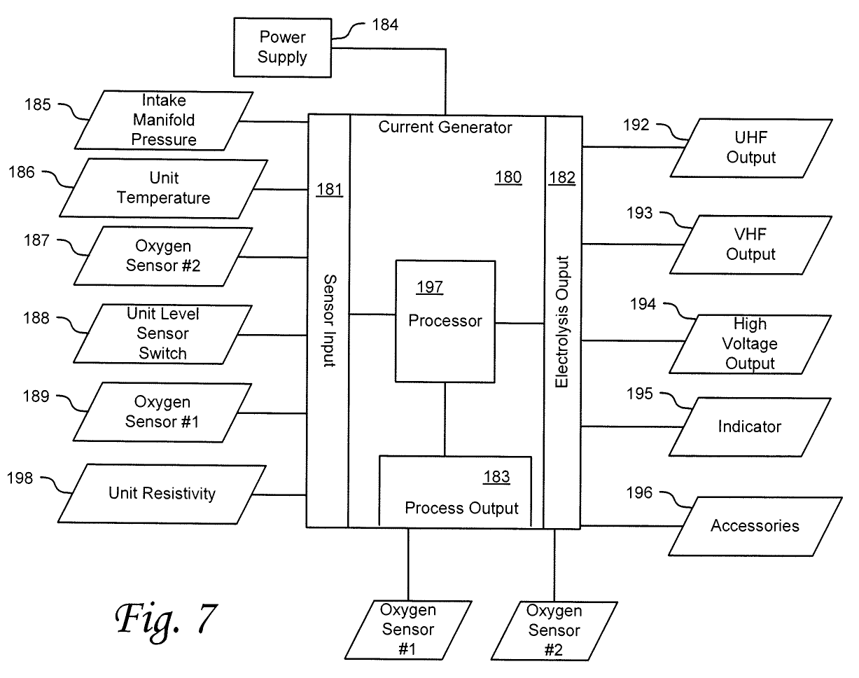

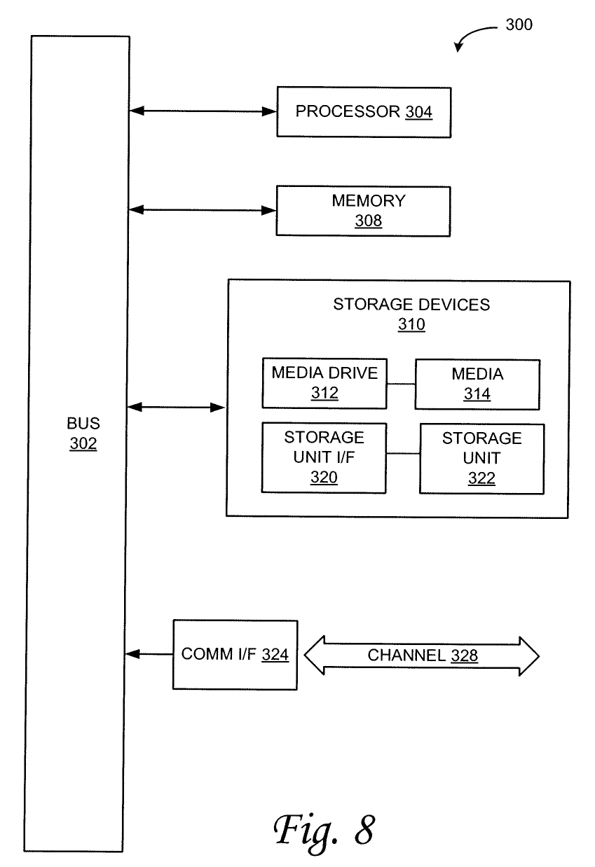

FIG. 7 illustrates a functional block diagram of an example waveform generator in accordance with one embodiment of the invention. Referring now to FIG. 7, waveform generating module 180 might include, for example, one or more processors, controllers, control modules, or other processing devices, such as a processor 197. Processor 197 might be implemented using a general-purpose or special-purpose processing engine such as, for example, a microprocessor, controller, or other control logic. Processor 197 may be connected to a bus (not shown), although any communication medium can be used to facilitate interaction with other components of waveform generating module 180 or to communicate externally. Waveform generating module 180 might also include a sensor input module 181. Sensor input module 181 may comprise a portion of a I/O interface as known in the art although any method for communicating external data to a computing unit or processor may be used. Waveform generating module 180 might also include a process output module 183. Process output module 183 may comprise a portion of a I/O interface as known in the art although any method for communicating to external sources from a computing unit or processor may be used. Waveform generating module 180 might also include an electrolysis output 182. Electrolysis output 182 may comprise a suitable power source outlet as known in the art or, alternatively, electrolysis output may comprise a signal source to enable further modules to provide a power source. Waveform generator may be powered by power supply 184. Power supply 184 may comprise the vehicle's power supply. For example, in a combustion engine vehicle, the power supply may comprise the alternator directly, or in other embodiments the power may be drawn from the vehicle's electronic control unit. In a hybrid vehicle, the power supply may comprise the vehicle's electric motor or electronic control unit. In some examples, the invention may be integrated into a vehicle's electronic control system (“ECU”). In these examples, the processor module may comprise the processor disposed within the ECU and the sensor input, process output modules, and electrolysis outputs may utilize a preexisting IO system within the ECU.

Referring still to FIG. 7, sensor input module 181 may be configured to receive data from a plurality of sensors. The plurality of sensors may comprise, for example, without limitation: (1) intake manifold pressure sensor 185; (2) oxygen sensor #1 189; (3) oxygen sensor #2 187; (4) unit temperature sensor 186; (5) unit resistivity sensor 198; and (6) unit level sensor switch 188. Sensor input module 181 may be further configured to provide the received data to processor module 197. Sensor data may be used to calculate the desired waveform to be supplied to the electrolysis device. For example, if data from the intake manifold pressure sensor 185, and oxygen sensors 189 and 187 indicate that the engine is under higher load, then the processor may supply a waveform which generates more hydrogen than normal. For example, by increasing the voltage or duty cycle of the provided waveform. As a further example, if the resistivity sensor 198 and the unit temperature sensor 186 indicate that the physical properties of the electrolysis liquid have changed, such as through increased temperature or higher ion dissolution, the processor may vary the frequency or high voltage pulse amplitude of the provided waveform. In some examples, the processing module may terminate operation of the device if until level sensor switch 188 indicates that the electrolysis liquid levels are too low. Or, in other examples, the unit level sensor switch 188 may be configured to automatically terminate the device operation itself, if liquid levels are too low.

Referring still to FIG. 7, some examples may include a process output module 183. In examples where the invention is not integrated with a vehicle ECU, it may be helpful to adjust the data that the oxygen sensors 190 and 191 provide to the vehicle's ECU. For example, once hydrogen is injected into the air/fuel mixture, the fuel will burn more efficiently, thus indicating to the oxygen sensors that the vehicle may utilize a leaner air/fuel mixture. This may create a feedback loop that results in an air/fuel mixture which is too lean even with the addition of hydrogen. The processor module may avoid this by utilizing process output module 183 to adjust the data provided by oxygen sensors 190 and 191 to the ECU.

Referring still to FIG. 7, the processor may be configured to supply signals to form the desired waveform through the electrolysis output module 182. Electrolysis output module 182 may be configured to send the signals to waveform generators, or may be configured to generate the desired waveform itself. Electrolysis output module 182 may comprise a plurality of various outputs. For example, without limitation, such outputs may comprise: (1) a UHF output 192; (2) a VHF output 193; (3) a High Voltage Output 194; (4) an indicator 195; and (5) various accessories 196. Some examples may include an indicator 195 electrically coupled to a signaling device disposed where visible in the car. For example, the indicator 195 could be an LED or display screen disposed on the vehicle's dashboard. In some examples the indicator may signal whether or not the device is operating. In other examples, the indicator may indicate the operative parameters of the device. Further examples may include a variety of accessories 196, as would be appreciated by those skilled in the art. For example, a global positioning system (GPS) unit accessory could be provided which would allow for greater predictive use of the electrolysis device.

Referring still to FIG. 7, the UHF output 192 may be configured to output a pulse wave that contains a waveform that is configured to efficiently separate gasses in an electrolysis device. For example, in an electrolysis device containing water the waveform may comprise a pulse wave at a frequency of 2.90 GHz, a voltage of 12V, and duty cycle of 50% Other examples may use different waveform parameters, for example frequency may be any frequency within 2-4 GHz, voltage may be within 1.2-50V and the duty cycle may be within 10%-90%. In other examples, the UHF output may be configured to output a plurality of different waveforms based on apparatus requirements. For example, the processor and UHF output may be configured to operate in a three-mode manner, as follows: Mode 1 may operate at a 2.90 GHz; Mode 2 may operate at 3.80 GHz; and Mode 3 may operate at 4.7 GHz. In other examples, the frequencies may be within a range for each mode. For example, Mode 1 may be at a range of 2-4 GHz, Mode 2 may be at a range of 3-5 GHz, and Mode 3 may be at a range of 4-6 GHz.

Other examples may include a VHF output 193. The VHF output 192 may be configured to output a pulse wave that contains a waveform that is configured to efficiently separate gasses in an electrolysis device. For example, in an electrolysis device containing water the waveform may comprise a pulse wave at a frequency of 380 MHz, a voltage of 12V, and duty cycle of 50%. The VHF output may also be configured to operate in a multi-mode configuration. For example, mode 1 may operate at 380 MHz, mode 2 may operate at 470 MHz, and mode 3 may operate at 650 MHz. In these multi-mode configurations, the UHF and VHF outputs may operate in the same mode at the same time, or may operate in different modes simultaneously. For example, the UHF and VHF outputs may be configured so that both operate in mode 1 at the same time, or they may be configured so that one is operating in mode 1 while the other is operating in mode 2.

Other examples may use different waveform parameters, for example the VHF frequency output may be any frequency within 300-450 MHz, the voltage may be within 1.2-50V and the duty cycle may be within 10% -90%. The VHF output wave and the UHF output wave may be superimposed, for example, without limitation, additively or multiplicatively, to obtain an superimposed wave that breaks down an electrolysis fluid with increased efficiency.

Further examples may include a High Voltage Output 194. In some examples, the High Voltage Output 194 is configured to supply a charge to electrodes in an electrolysis device. This charge allows the hydrogen ions and oxygen ions broken apart by the UHF and VHF waveforms to be collected at separate electrodes for formation into and separate collection of hydrogen and oxygen gas. In some examples, High Voltage Output 194 provides a DC current of 1500V. In other examples, High Voltage Output 194 may provide a DC current in the range of 200-2000V.

In other examples, High Voltage Output 194 may be configured to supply a high voltage waveform which also varies with time. In particular examples, the high voltage waveform may vary at a frequency of 43430 Hz or 143762 Hz. The high voltage waveform may be 1500 V peak to peak and may comprise a DC offset. For example, the high voltage waveform may have a 1500 V peak to peak waveform with a 500V DC offset. In certain examples, the High Voltage Output may be configured to one or the other of these frequencies. In other examples, the High Voltage Output may be configured to output both of these frequencies in a superimposed wave. In further example, the High Voltage Output may be further configured to superimpose sub harmonic frequencies onto the high voltage waveform. For example, the High Voltage Output might output a waveform at a 43430 Hz frequency superimposed with: a 21715 Hz frequency, a 14476.67 Hz frequency, a 15517.5 Hz frequency, and a 8686 Hz frequency. Or, if the waveform is output at 143762 Hz, sub-harmonics of 71881 Hz, 47920.67 Hz, 35840.1 Hz, and 28752.4 Hz might be superimposed. If both base frequencies are used, then High Voltage Output might output sub-harmonics of both of the base frequencies. Those of ordinary skill in the art will appreciate other harmonics or combinations of harmonics that may be used. For example, the 8686 Hz harmonic might be omitted.

Further examples may save energy by supplying the high voltage only during the off periods of the UHF and VHF waveforms. Because the electrolysis reaction takes place during the active periods of the UHF and VHF waveforms, the generated ions do not need to be collected until the off periods of the waveforms. By configuring the High Voltage Output to provide a high voltage waveform only during the off periods this collection may be achieved at lower energy use. Furthermore, in these examples, the High Voltage Output also has an off period. During this off period ions which have accumulated but not formed into hydrogen or oxygen gas are allowed to disperse. This dispersion prevents the resistivity of the electrolysis from increasing to an inefficient level. In other examples, the High Voltage Output may be further configured to provide a brief burst of opposite voltage to the electrodes. This burst may enable a more rapid dispersion of resistivity-increasing ions.

As used herein, the term module might describe a given unit of functionality that can be performed in accordance with one or more embodiments of the present invention. As used herein, a module might be implemented utilizing any form of hardware, software, or a combination thereof. For example, one or more processors, controllers, ASICs, PLAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

Where components or modules of the invention are implemented in whole or in part using software, in one embodiment, these software elements can be implemented to operate with a computing or processing module capable of carrying out the functionality described with respect thereto. After reading this description, it will become apparent to a person skilled in the relevant art how to implement the invention using other computing modules or architectures.

Where components or modules of the invention are implemented in whole or in part using software, in one embodiment, these software elements can be implemented to operate with a computing or processing module capable of carrying out the functionality described with respect thereto. One such example-computing module is shown in FIG. 8. Various embodiments are described in terms of this example-computing module 300. After reading this description, it will become apparent to a person skilled in the relevant art how to implement the invention using other computing modules or architectures.

Referring now to FIG. 8, computing module 300 may represent, for example, computing or processing capabilities found within desktop, laptop and notebook computers; hand-held computing devices (PDA's, smart phones, cell phones, palmtops, etc.); mainframes, supercomputers, workstations or servers; or any other type of special-purpose or general-purpose computing devices as may be desirable or appropriate for a given application or environment. Computing module 300 might also represent computing capabilities embedded within or otherwise available to a given device. For example, a computing module might be found in other electronic devices such as, for example, digital cameras, navigation systems, cellular telephones, portable computing devices, modems, routers, WAPs, terminals and other electronic devices that might include some form of processing capability.

Computing module 300 might include, for example, one or more processors, controllers, control modules, or other processing devices, such as a processor 304. Processor 304 might be implemented using a general-purpose or special-purpose processing engine such as, for example, a microprocessor, controller, or other control logic. In the example illustrated in FIG. 8, processor 304 is connected to a bus 302, although any communication medium can be used to facilitate interaction with other components of computing module 300 or to communicate externally.

Computing module 300 might also include one or more memory modules, simply referred to herein as main memory 308. For example, preferably random access memory (RAM) or other dynamic memory, might be used for storing information and instructions to be executed by processor 304. Main memory 308 might also be used for storing temporary variables or other intermediate information during execution of instructions to be executed by processor 304. Computing module 300 might likewise include a read only memory (“ROM”) or other static storage device coupled to bus 302 for storing static information and instructions for processor 304.

The computing module 300 might also include one or more various forms of information storage mechanism 310, which might include, for example, a media drive 312 and a storage unit interface 320. The media drive 312 might include a drive or other mechanism to support fixed or removable storage media 314. For example, a hard disk drive, a floppy disk drive, a magnetic tape drive, an optical disk drive, a CD or DVD drive (R or RW), or other removable or fixed media drive might be provided. Accordingly, storage media 314, might include, for example, a hard disk, a floppy disk, magnetic tape, cartridge, optical disk, a CD or DVD, or other fixed or removable medium that is read by, written to or accessed by media drive 312. As these examples illustrate, the storage media 314 can include a computer usable storage medium having stored therein computer software or data.

In alternative embodiments, information storage mechanism 310 might include other similar instrumentalities for allowing computer programs or other instructions or data to be loaded into computing module 300. Such instrumentalities might include, for example, a fixed or removable storage unit 322 and an interface 320. Examples of such storage units 322 and interfaces 320 can include a program cartridge and cartridge interface, a removable memory (for example, a flash memory or other removable memory module) and memory slot, a PCMCIA slot and card, and other fixed or removable storage units 322 and interfaces 320 that allow software and data to be transferred from the storage unit 322 to computing module 300.

Computing module 300 might also include a communications interface 324. Communications interface 324 might be used to allow software and data to be transferred between computing module 300 and external devices. Examples of communications interface 324 might include a modem or softmodem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications interface 324 might typically be carried on signals, which can be electronic, electromagnetic (which includes optical) or other signals capable of being exchanged by a given communications interface 324. These signals might be provided to communications interface 324 via a channel 328. This channel 328 might carry signals and might be implemented using a wired or wireless communication medium. These signals can deliver the software and data from memory or other storage medium in one computing system to memory or other storage medium in computing system 300. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to physical storage media such as, for example, memory 308, storage unit 320, and media 314. These and other various forms of computer program media or computer usable media may be involved in storing one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing module 300 to perform features or functions of the present invention as discussed herein.

While various embodiments of the present invention have been described above, it should be understood that they have been presented by way of example only, and not of limitation. Likewise, the various diagrams may depict an example architectural or other configuration for the invention, which is done to aid in understanding the features and functionality that can be included in the invention. The invention is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present invention. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

1. A signal generating apparatus, comprising:
a first signal generator configured to generate a time varying signal; and
a second signal generator electrically coupled to the first signal generator configured to generate an output signal using the time varying signal, the output signal having a waveform comprising a minimum voltage, a maximum voltage, a frequency, and a duty cycle;
wherein the second signal generator comprises an output electrically coupled to an electrolysis device configured to provide the output signal to the electrolysis device; and
wherein the output signal is configured to be used by the electrolysis device to charge electrodes disposed in the electrolysis device in electrolytic formation of hydrogen and oxygen gasses from water.

2. The apparatus of claim 1,
further comprising a third signal generator electrically coupled to the first signal generator configured to generate a second output signal having a waveform comprising a minimum voltage, a maximum voltage, a frequency, and a duty cycle;
wherein the third signal generator comprises a second output electrically coupled to the electrolysis device configured to provide the second output signal superimposed with the first output signal to the electrolysis device;
and wherein the second output signal is configured to be used by the electrolysis device to charge electrodes disposed in the electrolysis device in electrolytic formation of hydrogen and oxygen gasses from water.

3. The apparatus of claim 1, wherein the second signal generator generates the output signal from data received from a plurality of sensors.

4. The apparatus of claim 1, wherein the waveform further comprises a pulse wave.

5. The apparatus of claim 2,
wherein the second output signal comprises a high voltage waveform with the same frequency as the first output signal;
and wherein the second output signal is phase shifted with first output signal such that
the second output signal is at a low voltage when the first output signal is at a high voltage, and
the second output signal is at a high voltage when the first output signal is at a low voltage.

6. The apparatus of claim 3, wherein the sensors provide data from operation parameters of an engine.

7. The apparatus of claim 6, wherein the sensors further provide data from operation parameters of the electrolysis device.

8. The apparatus of claim 1, wherein the frequency of the output signal is within the range of 40 kHz to 45 KHz or is within the range of 140 kHz to 150 kHz.

9. The apparatus of claim 9, wherein
the second signal generator is further configured to output a first subharmonic output signal, the first subharmonic output signal having a frequency that subharmonic of the frequency of the first output signal, and
the output is further configured to provide the first subharmonic output signal to the electrolysis device superimposed with the first output signal.

10. The apparatus of claim 2, wherein the frequency of the first output signal is within the range of 40 kHz to 45 kHz and the frequency of the second output signal is within the range of 140 kHz to 150 kHz.

11. The apparatus of claim 10, wherein
the second signal generator is further configured to output a first subharmonic output signal, the first subharmonic output signal having a frequency that is a subharmonic of the frequency of the first output signal; and
the third signal generator is further configured to output a second subharmonic output signal, the second subharmonic output signal having a frequency that is a subharmonic of the frequency of the second output signal; and
wherein the first and second outputs are further configured to provide the first and second subharmonic output signals to the electrolysis device superimposed with the first and second output signals.

12. The apparatus of claim 3, wherein the second signal generator varies the duty cycle output signal based on the data.

13. A method for providing an electrical signal for an electrolysis device, comprising:
generating a time varying signal;
generating an output signal using the time varying signal, the output signal having a waveform comprising a minimum voltage, a maximum voltage, a frequency, and a duty cycle;
providing the output signal to an electrolysis device;
using the output signal to charge electrodes disposed in the electrolysis device in electrolysis of water into hydrogen and oxygen gasses.

14. The method of claim 13, further comprising,
generating a second output signal having a waveform comprising a minimum voltage, a maximum voltage, a frequency, and a duty cycle;
providing the second output signal superimposed with the first output signal to the electrolysis device;
using the second output signal to charge electrodes disposed in the electrolysis device in electrolysis of water into hydrogen and oxygen gasses.

15. The method of claim 13, further comprising
receiving data from a plurality of sensors of operation parameters of the engine or the electrolysis device; and
generating the output signal from the data.

16. The method of claim 13, wherein the waveform further comprises a pulse wave.

17. The method of claim 14,
wherein the second output signal comprises a high voltage waveform with the same frequency as the first output signal;
and wherein the second output signal is phase shifted with first output signal such that
the second output signal is at a low voltage when the first output signal is at a high voltage, and
the second output signal is at a high voltage when the first output signal is at a low voltage.

18. The method of claim 13, wherein the frequency is within the range of 40 KHz to 45 KHz or is within the range of 140 KHz to 150 KHz.

19. The method of claim 18, further comprising,
generating a first subharmonic output signal, the first subharmonic output signal having a frequency that subharmonic of the frequency of the first output signal, and
providing the first subharmonic output signal to the electrolysis device superimposed with the first output signal.

20. The method of claim 14, wherein the frequency of the first output signal is within the range of 40 kHz to 45 kHz and the frequency of the second output signal is within the range of 140 kHz to 150 kHz.

21. The method of claim 20, further comprising,
generating a first subharmonic output signal, the first subharmonic output signal having a frequency that is s subharmonic of the frequency of the first output signal;
generating a second subharmonic output signal, the second subharmonic output signal having a frequency that is a subharmonic of the frequency of the second output signal; and
providing the first and second subharmonic output signals to the electrolysis device superimposed with the first and second output signals.

22. The method of claim 15, further comprising varying the duty cycle of the output signal based on the data.

23. A vehicle with a hydrogen gas injection system, comprising:
a generator electrically coupled to an electrolysis device; and
the electrolysis device coupled to an air intake manifold;
wherein the generator comprises:
a first signal generator configured to generate a time varying signal; and
a second signal generator electrically coupled to the first signal generator configured to generate an output signal using the time varying signal, the output signal having a waveform comprising a minimum voltage, a maximum voltage, a frequency, and a duty cycle;
wherein the second signal generator comprises an output electrically coupled to the electrolysis device configured to provide the output signal to the electrolysis device; and
and wherein the electrolysis device is configured to generate hydrogen gas from water using the output signal to charge electrodes disposed in the electrolysis device in electrolytic formation of hydrogen and oxygen gasses from water, and to provide the hydrogen gas the air intake manifold.

24. The apparatus of claim 23,
wherein the generator further comprises a third signal generator electrically coupled to the first signal generator configured to generate a second output signal having a waveform comprising a minimum voltage, a maximum voltage, a frequency, and a duty cycle;
wherein the third signal generator comprises a second output electrically coupled to the electrolysis device configured to provide the second output signal superimposed with the first output signal to the electrolysis device;
and wherein the electrolysis device is configured to use the second output signal to charge electrodes disposed in the electrolysis device in electrolytic formation of hydrogen and oxygen gasses from water.

25. The apparatus of claim 23,
further comprising a plurality of sensors disposed in the vehicle to provide data to the generator, wherein the sensors provide data from operation parameters of an engine or from operation parameter of the electrolysis device; and
wherein the generator is further configured to use the data to generate the output signal.

26. The apparatus of claim 23, wherein the frequency of the output signal is within the range of 40 KHz to 45 KHz or is within the range of 140 KHz to 150 KHz.

27. The apparatus of claim 24, wherein the generator varies the duty cycle of the output signal based on the data.

28. The apparatus of claim 24,
wherein the second output signal comprises a high voltage waveform with the same frequency as the first output signal;
and wherein the second output signal is phase shifted with first output signal such that
the second output signal is at a low voltage when the first output signal is at a high voltage, and
the second output signal is at a high voltage when the first output signal is at a low voltage.
